(19) United States
(12) Patent Application Publication
(10) Pub. No.: US 2009/0187411 A1
(43) Pub. Date: Jul. 23, 2009

(54) METHOD FOR ENCODING A SOURCE AUDIO SIGNAL, CORRESPONDING ENCODING DEVICE, DECODING METHOD, SIGNAL, DATA CARRIER AND COMPUTER PROGRAM PRODUCT

(75) Inventors: Pierrick Philippe, Melesse (FR); Christophe Veaux, Paris (FR); Patrice Collen, Montgermont (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 12/278,882

(22) PCT Filed: Feb. 9, 2007
(86) PCT No.: PCT/FR07/50775

§ 371 Date: Aug. 8, 2008

(30) Foreign Application Priority Data
Feb. 9, 2006 (FR) 06 01175

(51) Int. Cl. G10L 19/00

(52) U.S. Cl. 704/500; 704/E19.001

(57) ABSTRACT

A method is provided for coding a source audio signal, involving the transformation of an amplitude/time space into a multi-component amplitude/phase/time space, including the sinusoidal modeling of the audio signal and the delivery of the sinusoidal components that change over time. The method includes the following steps in which: the components are compared to one another in order to define at least one group with at least two components using at least one similarity criterion; and, for at least one group, at least one reference datum is coded, the reference datum being represented by an evolved phase originating from a first component of the group, known as the reference component, and at least one complement datum is coded, the complement datum being associated with at least a second component from the group and, together with the reference datum, enabling the reconstruction of at least one piece of information that is representative of at least one component.

### CROSS-REFERENCE TO RELATED APPLICATIONS

This application is a Section 371 National Stage Application of International Application No. PCT/FR2007/050775, filed Feb. 9, 2007, and published as WO2007/091000 on Aug. 16, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the encoding and decoding of audio-digital signals and more specifically audio signals such as music or speech signals comprising a set of harmonics or sine waves.

A particular application of the disclosure is that of making improvements to the MPEG Audio (ISO/IEC 14496-3) standard which stipulates that audio data is modeled according to a parametrical encoding to enable transmission of sound and/or speech at very low bit rates.

More generally, the disclosure is situated in the context of the efficient transmission, storage and compression of sounds and music.

### BACKGROUND OF THE DISCLOSURE

A classic method for the efficient transmission of an audio signal consists first of all in breaking down this audio signal into sine components and then in transmitting information on these components so that a receiver is capable of restoring the signal on the basis of this information.

Indeed, these transmission techniques exploit the particular characteristics of a sine component according to which it is highly predictable and therefore transmissible at very low bit rates.

A detailed description is given here below of the breakdown of a signal into sine components as well as the classic techniques of decoding this type of signal.

### 1. Sinusoidal Analysis

The breakdown of audio signals into sinusoidal components is well known. For an exhaustive presentation of this technique, reference can be made especially to R. McAulay, T Quatieri, “Speech analysis/synthesis based on a sinusoidal representation”, IEEE Trans. on Acoustics, Speech and Signal Processing, Vol. 34(4), pp. 744-754, 1986 and Y. Medan, E. Yair and D. Chazan, “Super Resolution Pitch Determination of Speech Signals” IEEE Trans on Signal Processing, Vol. 39(1), pp. 40-48, 1991.

Sine modeling is based on the principle of a breakdown of a signal into a sum of sine waves having frequencies, amplitudes and phases variable in time (partial values) and of noise. In considering only a deterministic part of the audio signal x(t), the modeled signal x(t) is then expressed by:

$$\hat{x} ( t ) = {\sum }_{k = 0}^{K - 1} {a}_{k , n } cos ( {Φ}_{k , n} ( t ) ) , with \text{:}$$

nT≦t≦nT−1;
K corresponds to the total number of partial values contained in the signal;
a_{k,n} represents the amplitude of the partial value k during the frame indexed n;
Φ_{k,n}(t) represents the phase of the partial value k during the frame n;
T represents the number of samples describing a frame of analysis.

The phase Φ_{k,n}(t) of a partial value having an index k depends on its frequency f_{k,n} and on its initial phase φ_{k,0} such that:

Φ_{k,n}(t)=2πf_{k,n}t+φ_{k,0}.

The set of the three parameters (a_{k,n}, f_{k,n} and φ_{k,0}) thus enables the concise definition, over a time interval T, of the signal x(t) to be modeled.

### 2. Encoding of Sine Components

Reference may be made to the documents W. B. Kleijn and K. K. Paliwal, Speech Coding and Synthesis, Elsevier, Amsterdam, 1995, H. Pumhagen, N. Meine “HILN—The MPEG-4 Parametric Audio Coding Tools”, ISCAS 2000 Vol III pp 201-204 and B. den Brinker, E. Schuijers and W. Oomen, “Parametric coding for high-quality audio”, in Proc. 112nd AES Convention, Munich, Germany, 2002 for a detailed encoding and transmission of the sine components.

More generally, the encoding of sine components is aimed at encoding the parameters a_{k,n}, f_{k,n} and φ_{k,0} in condensed form through the introduction of a distortion of quantification. These quantified values are then represented in a compact way for example by means of a lossless encoding, i.e. encoding that reduces the information bit rate without affecting the signal with an additional error.

In most encoding/decoding systems, the phase components φ_{k,0} are not transmitted. This approach is based on the fact that the ear has poor perception of the influence of the phase on a musical signal. It is then only the paths of the frequency f_{k,n} and of the amplitude a_{k,n} that are encoded.

Classically, the values of the last two parameters are quantified and transmitted independently of one another through a scalar quantifier by the use of a logarithmic scale.

Another encoding technique called SSC (SinuSoidal Coding) for its part proposes an explicit encoding of the instantaneous phases.

It may be recalled that a sinusoidal component indexed k is represented in an analysis frame indexed n by a frequency f_{k,n}, an instantaneous phase φ_{k,n} and an amplitude a_{k,n}, considered to be constant during this frame. However, these three parameters evolve in the course of the signal and therefore vary from one frame to another.

For greater clarity, no description shall be provided here below in the document of the information elements on the transmission of the amplitude parameter a_{k,n} since this parameter does not fall within the scope of the present invention.

These temporal changes in frequency and phase may be respectively represented by temporal functions which will be denoted by fₖ(t) and φₖ(t). The encoding of these elements is described in detail in Appendix A.

In the context of the transmission, encoding and storage of audio signals, it is therefore noted that the prior-art techniques propose the transmission of the sinusoidal components either by the independent estimation and encoding of the phases and frequencies analyzed or in conjunction, through the use of the evolved phase. Furthermore, whatever the technique used, this information must be transmitted for each of the components.

In general, these prior-art techniques for the encoding of sinusoidal components are costly in terms of bit rate or storage memory. Indeed, it is necessary to send at least one piece of information for each analysis frame. Furthermore, this operation is reiterated for each of the sinusoidal components of the sound signal to be transmitted, since they are analyzed and processed independently of one another.

This implies numerous and costly steps of quantification, encoding, transmission or storage. Such techniques impair the efficiency of transmission or storage.

Finally, the prediction techniques implemented are efficient only when the frequency of the partial value considered is relatively stable in time. If this is not the case, the temporal prediction error becomes great, considerably increasing the distortion during the rebuilding of the audio signal.

### SUMMARY

An aspect of the disclosure relates to a method for encoding a source audio signal comprising a step of transformation of an amplitude/time space into a multi-component space described in terms of amplitude, phase and time, implementing a sinusoidal modeling of the audio signal and delivering a plurality of sinusoidal components varying in time. According to an embodiment of the invention, the encoding method comprises the following steps:
comparing said components with one another so as to define at least one group of at least two components according to at least one predetermined similarity criterion;
encoding the following for at least one of the groups:
   at least one piece of reference data of the group, said reference data being represented by an evolved phase derived from a first component of said group, called reference component;
   at least one piece of complementary data associated with at least one of the components of the group and enabling the rebuilding, in combination with the reference information, of at least one piece of information representing at least one component.

Thus, an embodiment of the invention relies on a novel and inventive approach to the encoding of a source audio signal exploiting the characteristics of the sinusoidal components that constitute it. Indeed, the method of an embodiment of the invention groups together and encodes the sinusoidal components of the signal having a degree of similitude. It is thus possible to rebuild each of the components of a group from knowledge of the reference component and of the corresponding piece of complementary data. A technique of this kind averts the encoding of all the components independently of one another and thus presents a very great gain in terms of information to be quantified, predicted, stored or, again, transmitted.

Advantageously, the criterion of similarity takes account of an evolution of the phase of at least two components. An evolution in phase of this kind is thus called an evolved phase.

In one advantageous embodiment, the comparison step implements a computation of correlation between the evolution in phase of the two components.

The coefficient of correlation enables the reflection, according to its value, of a degree of resemblance.

Advantageously, the encoding step implements a differential encoding along a time axis comprising:
a step of prediction of the piece of reference data and/or of the piece of complementary data relative to at least one corresponding preceding value;
a step of determining at least one residue to be encoded, by difference between a predicted value and a real value.

Advantageously, the residue is encoded according to a period that is a multiple of the component extraction sampling period, and a piece of information representing the multiple is generated.

This multiple is also called a decimation factor. Thus, there is a gain in terms of quantity of information to be encoded and quantified.

Advantageously, the encoding step implements a differential encoding along a frequency axis comprising:
a step of encoding at least one piece of reference data, representing a reference component of said group;
a step of encoding at least one piece of complementary data representing another component of the group, by comparison with the piece of reference data.

Advantageously, the encoding step implements the following equations for each component indexed k:

$${\hat{Φ}}_{k , n} = {\tilde{Φ}}_{k , n - 1} + \frac{{α}_{k}}{{α}_{l}} ( {\tilde{Φ}}_{l , n} - {\tilde{Φ}}_{l , n - 1} ) ;$$

$${d}_{k , n} = {Φ}_{k , n} - {\hat{Φ}}_{k , n} , where$$

n is the time index;
Φ_{k,n} is the value at an instant indexed n of the phase of the component indexed k;
\hat{Φ}_{k,n} is a piece of prediction data at an instant indexed n, of the phase of the component indexed k;
\tilde{Φ}_{k,n-1} is a piece of quantified data at an instant indexed n−1, of the phase of the harmonic component indexed k;
\tilde{Φ}_{l,n-1} is a piece of quantified data at an instant indexed n−1, of the phase of the component indexed l;
aₖ and aₗ are values proportional to the basic frequencies of the components k and l, chosen so that the ratio of these values represents a ratio of frequency between the sinusoidal component indexed k and the sinusoidal component indexed l;
d_{k,n} is a residue value at an instant indexed n, between the phase value and the prediction data of the component indexed k.

An embodiment of the invention furthermore pertains to a computer program product for the implementation of the encoding method as described here above.

An embodiment of the invention also relates to a device for the encoding of a source audio signal comprising means to implement a method of this kind.

An embodiment of the invention also relates to an encoded signal representing a source audio signal, for which the components of such a signal are grouped together in at least one group of at least two components according to at least one predetermined similarity criterion, each of the groups comprising:
at least one piece of reference data of the group, said reference data being represented by an evolved phase derived from a first component of said group, called reference component;
at least one piece of complementary data associated with at least one of the components of the group and enabling the rebuilding, in combination with said piece of reference information, of at least one piece of information representing at least one component.

This signal can of course comprise different pieces of information produced by the encoding method described here above.

An embodiment of the invention also relates to a data carrier comprising at least one such encoded signal.

An embodiment of the invention furthermore pertains to a method for the decoding of an encoded signal of this kind. This method comprises the following steps:
obtaining the piece or pieces of reference data and the piece or pieces of complementary data;
rebuilding the information or pieces of information representing components, on the basis of the reference and complementary data.

A decoding method of this kind enables the decoding of a signal encoded according the encoding method of an embodiment of the invention as described here above.

Advantageously, a decoding method of this kind comprises a step for building a rebuilt audio signal, representing the source audio signal, in taking account of the information representing the components.

According to an embodiment of the invention, a decoding method of this kind comprises especially:
a step for the decoding of at least one piece of reference data, representing a reference component of the group;
a step for the decoding of at least one piece of complementary data representing another component of the group, by comparison with the piece of reference data;
a step for rebuilding another component by combination of the piece of reference data and the piece of complementary data.

The decoding method can thus be used to efficiently rebuild the components that have a harmonic link with a reference component (with implementation of an “inter” decoding).

Advantageously, since the piece of complementary piece of data has already been encoded in a period that is a multiple of a sampling period, the decoding method includes a step of interpolation of a piece of complementary data estimated for the instants for which a piece of complementary data has not been encoded.

Advantageously, the step of building the phase evolution implements the following equation:

$${\tilde{Φ}}_{k , n} = {\tilde{Φ}}_{k , n - m} + ( {\tilde{Φ}}_{l , n} - {\tilde{Φ}}_{l , n - m} ) \frac{{\overline{f}}_{k}}{{\overline{f}}_{l}} + {Δ}_{p} * q [ index ] where \text{:}$$

\tilde{Φ}_{k,n-m} is a piece of quantified data at an instant indexed n−m, of the rebuilt phase of the component indexed k;
\tilde{Φ}_{l,n} is a piece of quantified data, at an instant indexed n, of the rebuilt phase of the component indexed l;
\tilde{Φ}_{l,n-m} is a piece of quantified data, at an instant indexed n−m, of the rebuilt phase of the component indexed l;
f̅ₖ is a value of the rebuilt frequency corresponding to the component indexed k;
f̅ₗ is a value of the rebuilt frequency corresponding to the component of the reference group;
Δₚ is a quantification step;
q[index] is an integer value corresponding to a quantified correction value.
   Advantageously, a decoding method of this kind comprises:
a step of prediction along a time axis of the reference data relative to at least one corresponding preceding value, delivering at least one piece of predicted data;
a step of addition, to at least one of the predicted pieces of data, of a corresponding residue transmitted in the signal so as to obtain a rebuilt real piece of data.

The decoding method of an embodiment of the invention thus enables the rebuilding of data not transmitted by prediction (with implementation of an “intra” decoding method.

Advantageously, the residue is encoded in a period that is a multiple of a sampling period, and the decoding method comprises a step of interpolation of an estimated residue estimated for the instants for which a residue has not been encoded.

More specifically, the decoding method can implement the following equation:

\tilde{Φ}_{k,n}=2*\tilde{Φ}_{k,n-m}−\tilde{Φ}_{k,n-2m}+Δₚ*q[index] where:
\tilde{Φ}_{k,n-m} is a piece of quantified data, at an instant indexed n−m, of the rebuilt phase of the component indexed k;
\tilde{Φ}_{k,n-2m} is a piece of quantified data, at an instant indexed n−2m, of the rebuilt phase of the component indexed k;
Δₚ is a step of quantification of a quantification error;
q[index] is an integer value corresponding to a quantified correction value.

An embodiment of the invention also relates to a computer program product for the implementation of the decoding method as described here above.

Finally, an embodiment of the invention relates to a device for the decoding of an encoded signal representing a source audio signal. According to an embodiment of the invention, the signal comprising a representation of the source signal in the form of a plurality of sinusoidal components described in a space of representation in amplitude, phase and time,

the components being grouped together in at least one group of at least two components according to at least one criterion of similarity, each of the groups comprising:
at least one piece of reference data of the group, said reference data being represented by an evolved phase derived from a first component of said group, called reference component;
at least one piece of complementary data associated with at least one of the components of the group and enabling the rebuilding, in combination with the piece of reference information, of at least one piece of information representing a component,
   the device comprises:
means to obtain the piece or pieces of reference data and the piece or pieces of complementary data;
means to rebuild the piece or pieces of information representing components from the pieces of reference and complementary data.

A device of this kind can especially implement the decoding method as described here above and comprises the means needed to do this.

### BRIEF DESCRIPTION OF THE DRAWINGS

1. List of Figures

Other features and advantages shall appear more clearly from the following description of a preferred embodiment, given by way of a simple illustrative and non-exhaustive example and from the appended drawings of which:

FIG. 1 illustrates the linear prediction described in Appendix A;

FIG. 2 is a simplified flow chart of the encoding method according to an embodiment of the invention;

FIG. 3 is a graph showing the progress of the phases and frequencies of the sinusoidal components of a source audio signal;

FIG. 4 is a flow chart of the decoding method according to an embodiment of the invention

FIGS. 5A and 5B schematically illustrate an encoding device and a decoding device that implement an embodiment of the invention.

### DETAILED DESCRIPTION OF ILLUSTRATIVE EMBODIMENTS

### 1. General Principle

An embodiment of the invention therefore proposes a wholly novel and efficient approach to the encoding of a harmonic signal enabling its transmission or its storage to be improved by reducing the bit rate needed for transmission or the memory space needed for storage while at the same time providing a high-quality rebuilt signal, in achieving this even when the frequency variations in the course of time are great.

To this end an embodiment of the invention, in a novel and efficient way, exploits the fact that the sinusoidal components of a signal are closely linked.

Indeed, if we consider a harmonic or quasi-harmonic signal, there is a known way of defining the following relationship between a harmonic reference component (often called a fundamental component), with a frequency referenced f_{0,n} with the frame indexed n, and a harmonic component of the same signal which is called a complementary component indexed k, at the frequency denoted f_{k,n}:

f_{k,n}=f_{0,n}·k\sqrt{1+(k²−1)β}

β represents a factor of inharmonicity close to zero which can be overlooked for the vocal sounds for example. For example, this factor of inharmonicity is equal to 0.0004 for the piano.

αₖ then denotes the ratio between the frequency f_{k,n} of the component indexed k and the frequency f_{0,n} of the reference component indexed 0, giving:

$${α}_{k =} \frac{{f}_{k , n}}{{f}_{0 , n}} .$$

In other words, each component indexed k has a corresponding factor αₖ, reflecting a relationship of harmonicity with the reference component.

Another major characteristic of an embodiment of the invention consists of the transmission of certain pieces of information, especially complementary information obtained by differential encoding with time plus space refreshing. A technique of this kind is used to further reduce the necessary bit rate without affecting the quality of the rebuilt signal, especially for the most stable frequency components.

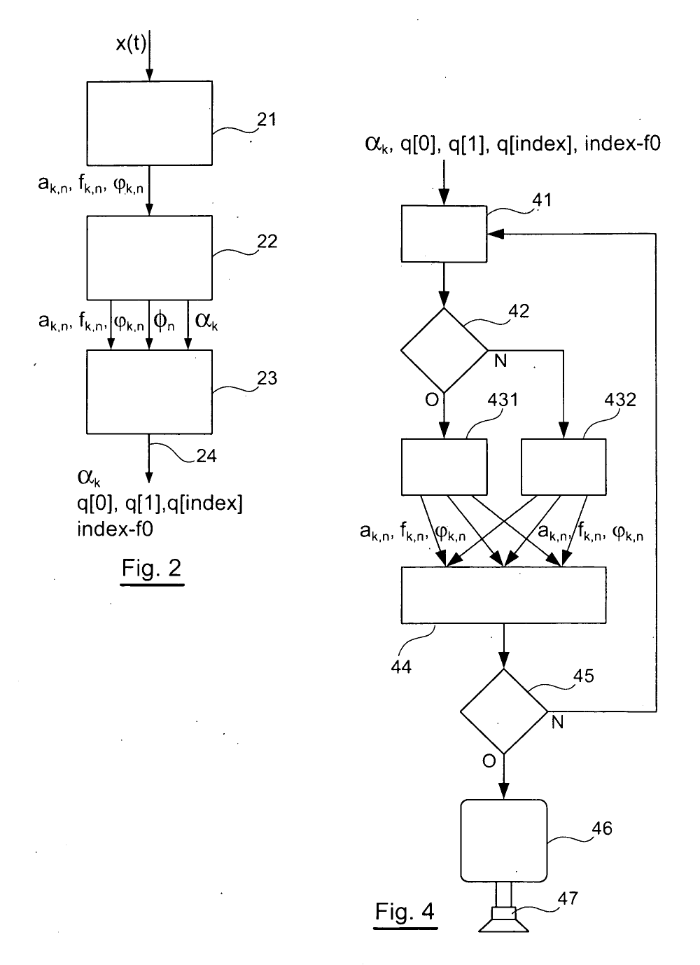

Referring to FIG. 2, the block diagram of a system of analysis for the transmission and encoding of an audio signal as proposed by an embodiment of the invention generally comprises three main steps.

A sound signal x(t) is processed in a step 21 of sinusoidal analysis, in which the audio signal x(t) is broken down into sinusoidal entities and in which, for each component indexed k, the information on amplitude a_{k,n}, phase φ_{k,n} and finally frequency f_{k,n} is extracted from the signal at each frame indexed n. A signal \hat{x}(t) is obtained close to x(t) having the form:

$$\hat{x} ( t ) = {\sum }_{k = 0}^{K - 1} {a}_{k , n } cos ( {Φ}_{k , n} ( t ) ) ,$$

as described in the introduction.

There then follows the step 22 for matching harmonic entities or sinusoidal entities in which they are grouped together by harmonic families: this is a work of classification in which the sinusoidal components having a harmonic relationship with one another are identified.

This matching step 22 can be obtained by comparing especially the evolved phases of each component. A step of this kind enables the definition, for a sinusoidal component indexed k, of a sinusoidal reference component whose evolved phase is denoted Φₙ as well as a piece of complementary data αₖ, representing the relationship existing between this last component and the reference component. Thus, it will be possible to rebuild the component indexed k simply on the basis of information transmitted on the reference component (such as its evolved phase Φₙ) as well as this complementary piece of data αₖ.

The complementary piece of data αₖ, the evolved phase Φₙ of the reference component as well as the information on phase, amplitude and frequency of the component indexed k are then quantified and encoded in a step 23. The quantified data representing the signal x(t) is then transmitted (24). Quantified data of this kind comprises especially the values \hat{α}ₖ and the quantified base frequency values (denoted index_f0), as well as the initial phase of the basic reference, denoted q[0] as well as parameters representing prediction error during the encoding, denoted q[1], q[index]. These last quantified parameters representing the encoded audio source signal are integer values which are multiplied by a corresponding quantification step during the rebuilding of the signal. They are explained in greater detail here below in the present description.

It is on the basis of this data that the harmonic indexed k can be rebuilt by a decoder without any loss of quality.

A more detailed description shall now be given of the steps 22 and 23 for matching harmonic entities and for quantification and encoding.

### 2. Matching of the Harmonic Entities

### Step 22

The sinusoidal analysis step 21 presented with reference to FIG. 2 therefore makes it possible to obtain a representation, for each of the sinusoidal components of the signal, of the changes in their phase and frequency. The term used therefore is evolved phase. These components are illustrated in FIG. 3. The x-axis represents time in terms of frames indexed n and the y-axis represents the evolved phase in radians.

The idea here is to make use of this knowledge of the evolved phases to identify groups of resemblance between a certain number of harmonics.

It can be seen especially from FIG. 3 that it is possible to determine three groups or entities, 31, 32, 33. It can be noted that the entities 31 and 32 each include a group of components, represented by their evolved phase, while the entity 33 contains only one sinusoidal component.

To obtain the matching step, it is possible for example to compute the correlation components ρ_{k,l} between two harmonic components respectively indexed k and l of the evolved phase differentiated by the formula:

$${ρ}_{k , l} = \frac{{\sum }_{n = 1}^{n = N - 1} ( {d}_{k , n} - {\overline{d}}_{k} ) ( {d}_{l , n} - {\overline{d}}_{l} )}{\sqrt{{\sum }_{n = 1}^{n = N - 1} {( {d}_{k , n} - {\overline{d}}_{k} )}^{2} \cdot {\sum }_{n = 1}^{n = N - 1} {( {d}_{l , n} - {\overline{d}}_{l} )}^{2}}} with \text{:}$$

d_{k,n}=Φ_{k,n}−Φ_{k,n-1}, i.e. the differentiated evolved phase between the frame indexed n and the frame indexed n−1 for the component indexed k;

$$- {\overline{d}}_{k} = \frac{1}{N - 1} {\sum }_{n = 1}^{n = N - 1} {Φ}_{k , n} - {Φ}_{k , n - 1} ;$$

N is the number of time-related instants common to the components k and l.

An example of results of correlation components is set forth in the following table:

| | l | | | | | | | | | |
|---|---|---|---|---|---|---|---|---|---|---|
| k | 1 | 2 | 3 | 4 | 5 | 6 | 7 | 8 | 9 | 10 |
| 1 | 1.0000 | 0.9927 | 0.9914 | 1.0000 | 0.9920 | 0.9912 | −0.1568 | −0.1543 | −0.1443 | 0.2549 |
| 2 | 0.9927 | 1.0000 | 0.9798 | 0.9927 | 0.9882 | 0.9848 | −0.0377 | −0.0365 | −0.0225 | 0.2843 |
| 3 | 0.9914 | 0.9798 | 1.0000 | 0.9914 | 0.9857 | 0.9910 | −0.3137 | −0.3094 | −0.3017 | 0.2120 |
| 4 | 1.0000 | 0.9927 | 0.9914 | 1.0000 | 0.9920 | 0.9912 | −0.1568 | −0.1543 | −0.1443 | 0.2549 |
| 5 | 0.9920 | 0.9882 | 0.9857 | 0.9920 | 1.0000 | 0.9837 | −0.0144 | −0.0128 | −0.0023 | 0.3152 |
| 6 | 0.9912 | 0.9848 | 0.9910 | 0.9912 | 0.9837 | 1.0000 | −0.0194 | −0.0136 | −0.0053 | 0.3568 |
| 7 | −0.1568 | −0.0377 | −0.3137 | −0.1568 | −0.0144 | −0.0194 | 1.0000 | 0.9998 | 0.9993 | 0.3667 |
| 8 | −0.1543 | −0.0365 | −0.3094 | −0.1543 | −0.0128 | −0.0136 | 0.9998 | 1.0000 | 0.9996 | 0.3665 |
| 9 | −0.1443 | −0.0225 | −0.3017 | −0.1443 | −0.0023 | −0.0053 | 0.9993 | 0.9996 | 1.0000 | 0.3832 |
| 10 | 0.2549 | 0.2843 | 0.2120 | 0.2549 | 0.3152 | 0.3568 | 0.3667 | 0.3665 | 0.3832 | 1.0000 |

The similarity between components is therefore measured by the computation of the correlation coefficient. Two components indexed respectively k and l are deemed to belong to the same entity when the value of the correlation coefficient is above a threshold, for example a threshold with a value τ=0.95.

Referring now to FIG. 3 and the above table, it can then be seen that the components having the same evolved phases indexed 311, 312, 313, 314, 315 and 316 belong to the same entity 31.

Similarly, the components having evolved phases indexed 321, 322 and 323 belong to a same second entity 32. Finally, the evolved phase component 331 has no similitude with any other component since the coefficient of correlation of this component, with any other component, is low. By itself, it then represents a third entity 33.

The entities having a harmonic relationship, namely the entities 31 and 32, are thus brought together and each of the partial values is assigned a factor αₖ, or complementary data, denoting its harmonic ratio with a reference component whose evolved phase is denoted Φₙ, and then represents the trajectory common to the entity considered.

The evolved phase with the frame indexed n of the harmonic component indexed k is then expressed as a function of the evolved phase of the reference component by the following formula:

Φ_{k,n}=αₖ·Φₙ+Φ_{k,0}+b_{k,n} with:
b_{k,n} represents the random noise explaining the measurement error made on the frequencies and phases as well as a mismatching of these measurements relative to the harmonic model;
αₖ is the factor previously introduced by the relationship:

αₖ=k·\sqrt{1+(k²−1)β};
Φ_{k,0} is an initial phase correction.

It is then noted, from this formula, that it is possible to obtain the value of an evolved phase of a component indexed k at the frame indexed n from the evolved phase of a reference component.

In one particular embodiment, it is possible to compute the values of Φₙ and αₖ by iteration until the convergence of the following two equations:

$${α}_{k} = \frac{{\sum }_{n = 0}^{n = N - 1} {Φ}_{n} \cdot {Φ}_{k , n}}{{\sum }_{n = 0}^{n = N - 1} {Φ}_{n}^{2}} et$$

$${Φ}_{n} = \frac{{\sum }_{k = 0}^{k = K - 1} {α}_{k} {Φ}_{k , n}}{{\sum }_{k = 0}^{k = K - 1} {α}_{k}^{2}} .$$

These two relationships can be considered in pieces: if, for example, the components 311 and 312 of FIG. 3 cover only one common interval N₁<N, then the formula used to compute Φₙ will be applied only to the portions common to the two components and the formula enabling the computation of αₖ will not integrate the indices that are not shown (N being the number of the common time-related instants defined here above).

It will be noted that, depending on the embodiment chosen, it is possible to choose an initial value of Φₙ which is one of the evolved phases of the components indexed k, or also it is possible to choose: Φₙ=1∀nε[0,N−1].

Furthermore, in another embodiment, the power of b_{k,n}, referenced σₖ², can also serve for the matching: the sinusoidal components accurately meeting the previous equation will indeed be affected by a low variance σₖ². In an additional embodiment, this matching can also be done by means of a criterion of maximum likelihood, by maximizing the probability of Φ_{k,n} knowing the model described by Φₙ and the values αₖ. These a posteriori measurements will therefore confirm the matching done according to the principle of the correlation presented.

In other words, and in a first embodiment, each component indexed k, with an evolved phase noted Φ_{k,n} will be perfectly described by the transmission (or storage) of an evolved phase Φ_{l,n} of a reference component indexed l chosen from among the sets K of the components of the signal, the factors αₖ as well as the parameters b_{k,n} with the index k having a value different from that of the index l.

In a second embodiment, for each reference evolved phase, a reference value Φₙ common to all the components of the signal to be transmitted is transmitted, and then for each component, the factors αₖ and the parameters b_{k,n} with 0≦k≦K−1.

### 3. Quantification and Encoding

### Step 23

The knowledge of the development of the frequencies and of the phases of each sinusoidal components as well as the relationships of similarity between each of them is exploited here for optimal encoding.

Following the matching step, the sinusoidal entities are grouped together in two families. These are a first family comprising links of harmonicity and a second family of components that are mutually independent (of the type similar to the entity 33 presented with reference to FIG. 3).

In the context of the transmission of entities belonging to the first family, it is then necessary, for a component indexed k, to transmit the reference signal whose evolution in phase and frequency is denoted Φₙ or else Φ_{l,n}, according to the embodiment chosen, the estimation error b_{k,n} as well as the factor αₖ, reflecting the harmonicity of the component indexed k with the reference component. The estimation error b_{k,n} is a residue value used to compensate for the prediction error during the rebuilding of the signal.

According to the parameter to be encoded and the family to which the entity considered belongs, we consider two types of encoding, presented here below, respectively called Intra encoding and Inter encoding.

3.1 Intra Encoding

The Intra component quantification mode consists of the quantification of a phase and frequency evolution or evolved phase in relation to itself, without reference to any other component. This description is based on a linear prediction technique known per se. In other words, the value of the evolved phase is predicted at an instant, on the basis of its value at the preceding instants. According to a preferred embodiment of the invention, this prediction technique is extended by using temporal decimation operations, so as to reduce the bit rate needed to transmit information.

For example, the linear prediction of the evolved phase of the component indexed k at the instant n+2m, referenced \hat{Φ}ₙ₊₂ₘ is computed as follows:

\hat{Φ}ₙ₊₂ₘ=2·\tilde{Φ}_{k,n+m}−\tilde{Φ}_{k,n} with
\tilde{Φ}_{k,n+m} being the quantified value of Φ_{k,n+m};
m is a temporal decimation factor representing a multiple period of the sampling period;

$$- {Φ}_{k , n + l} = \frac{1}{m} [ ( m - 1 ) {\tilde{Φ}}_{k , n} + l \cdot {\tilde{Φ}}_{k , n + m} ] with$$

$$1 \leq l \leq m - 1.$$

If the duration of the signal is not exactly a multiple of m, then the ends are extrapolated in linear form in using the last values received by the decoder.

We then obtain a residue value referenced ε_{k,n} which will be effectively transmitted (or stored) in a form that is quantified and encoded at the instants n=l·m, which are multiples of m equal to: ε_{k,n}=Φ_{k,n}−\hat{Φ}_{k,n}. This signal represents a divergence between the real value and the predicted value of the progress in frequency and in phase.

A method of this kind is particularly effective for transmitting components whose frequency varies little in time. Indeed, it must be ensured that the rebuilding error increases through this temporal decimation which furthermore provides for a major reduction in the transmission bit rate. The reduction of the bit rate will be all the greater as Φ_{k,n} describes a straight line in pieces.

The elements or entities encoded and quantified according to this type of intra encoding are then the following:
the decimation factor m;
the set of signals \tilde{ε}_{k,n}, values quantified by ε_{k,n} at the instants that are multiples of m; the quantification will for example be achieved by a scalar quantifier (which may or may not be uniform) or a vector quantifier. This quantification may be followed by an entropic encoder of the Huffman or arithmetical type.
the initial quantified values needed for the predictor \tilde{Φ}_{k,0} and \tilde{Φ}_{k,m}. To this end, it is possible to transmit an initial frequency f_{k,0} enabling the retrieval of the progress \tilde{Φ}_{k,m} by the relationship: \tilde{Φ}_{k,m}=\tilde{Φ}_{k,0}+mαTf_{k,0}.

These values can be quantified by a scalar quantifier (which may or may not be uniform) and possibly also encoded by a variable length code. Suitable values for m cover the range 1≦m≦16.

In other words, a differential encoding is implemented herein along a time axis.

3.2 Inter Encoding

What is to be done now is to jointly encode a sinusoidal component relative to another, by using their relationship of harmonicity or similarity.

An expression is given of the progress of the phase and frequency Φ_{k,n} of a component indexed k at an instant of a frame indexed n relative to a component whose progress is denoted Φ_{l,n} indexed l, which for its part is harmonically related to it. In order to obtain operation identical in terms of both the encoder and the decoder, the values Φ_{k,n} will be expressed relative to a quantified version of Φ_{l,n} denoted \tilde{Φ}_{l,n}.

This type of encoding is called Inter encoding.

Thanks to the relationship of harmonicity, a predicted value of Φ_{k,n}, denoted \tilde{Φ}_{k,n} is obtained by the following relationship:

$${\hat{Φ}}_{k , n} = {\tilde{Φ}}_{k , n - 1} + \frac{{α}_{k}}{{α}_{l}} ( {\tilde{Φ}}_{l , n} - {\tilde{Φ}}_{l , n - 1} ) .$$

It can be seen through this formula that the value at an instant n of the evolved phase of a component encoded by Inter encoding is obtained firstly from its predicted values at a preceding instant n−1 (\tilde{Φ}_{k,n-1}), and secondly from the predicted value of the evolved phase of a component with a reference indexed l at the instants n and n−1 (\tilde{Φ}_{l,n} and \tilde{Φ}_{l,n-1}).

It is then a prediction error d_{k,n} that will be transmitted in quantified form: d_{k,n}=Φ_{k,n}−\hat{Φ}_{k,n}. Indeed, the knowledge of this error by the decoder of the rendering device is useful to correct the prediction error generated at encoding and thus provide for high quality of the rebuilt audio signal.

Through this prediction error, it will be possible to precisely rebuild the harmonic indexed k by means of the referenced component indexed l.

More specifically, the signal d_{k,n} is the prediction error of the harmonic indexed k relative to the reference harmonic indexed l, totalized with the quantification error performed on Φ_{l,n}. If \tilde{Φ}_{l,n} is quantified with sufficient precision, then d_{k,n} represents only the inter-harmonic prediction error.

In a preferred embodiment, this type of Inter encoding too can rely on a decimated version of Φ_{l,n}. Similarly, the signals d_{k,n} too can be transmitted in decimated form. The prediction of \hat{Φ}_{k,n} can then be expressed in the form:

$${\hat{Φ}}_{k , n} = {\tilde{Φ}}_{k , n - m} + \frac{{α}_{k}}{{α}_{l}} ( {\tilde{Φ}}_{l , n} - {\tilde{Φ}}_{l , n - m} ) .$$

In this case, d_{k,n} will be transmitted only for the indices n multiplied by m.

In short, the elements transmitted in the case of Inter encoding are therefore the following:
a basic component (transmitted in Intra mode according to the preferred embodiment);
the values of the complementary data or factor αₖ, transmitted either directly or in the form of a frequency f̅ₖ which enables

$${α}_{k} = \frac{{\overline{f}}_{k}}{{\overline{f}}_{l}}$$

to be found in relation to the reference component indexed l;
the prediction errors d_{k,n} quantified or not quantified in decimated form;
the initial evolved phases Φ_{k,0} quantified by a scalar quantifier (which may or may not be uniform) and possibly encoded by a code of variable length (arithmetic code or Huffman code for example).

An embodiment of the invention also covers the transmission of a common Intra signal Φₙ matched with αₖ and φ_{k,0} but without transmission of d_{k,n}, Φₙ possibly representing a component to be rendered (i.e. a value Φ_{n,k}) or not depending on the embodiment chosen.

In conclusion, the inventors have noted that the performance of these types of encodings implementing decimation is advantageous. For example, the bit rate characteristic as a function of the distortion of an Intra encoding with decimation by a factor two provides for a substantial saving in bit rate as compared with the Intra type transmission without decimation, namely a saving of about 30%.

In terms of performance, if the frequency of the evolved phase Φ_{l,n} of the reference component varies swiftly in time, then the cost of transmission, in Intra encoding, will be high because the temporal predictive model will be poorly complied with. By contrast, when the quantification of the evolved phases Φ_{k,n} of the components related to this signal are pushed, then the effects of the time-related variations will have disappeared: the encoding in Inter mode will therefore be particularly suited to the harmonic components having high temporal variations.

### 4. Decoding Method

An embodiment of the invention furthermore concerns the method for the decoding of a signal encoded and quantified as described here above. Here again, depending on the type of encoding (Intra mode or Inter mode) performed, two types of decoding are envisaged.

FIG. 4 is a general block diagram of the decoding method of an embodiment of the invention. A binary string containing quantified data (q[0], q[1], q[index], index_f0, α . . . ) representing a frame indexed n of the quantified source audio signal is first of all decoded in a syntactic decoding step 41. Reference may be made to the appendix B of the present description for detailed information on this step 41.

There then follows a test step 42 for testing the type of encoding by which the received frame has been encoded: <<mode==inter ?>>. If the response to this test is yes, a decoding step 431 for decoding in Inter mode is implemented. If not, the frame is decoded in Intra mode in a step 432.

Then, at output of each of each of the decoding steps 431 and 432 the desired information on phase φ_{k,n} and frequency f_{k,n} and amplitude a_{k,n} is obtained.

These pieces of information are then exploited in a sinusoidal synthesis step 44 in which the sinusoidal component considered is rebuilt.

Finally, a test 45 is performed to determine whether the processed component is the last one or not: <<Last component?>>. If not, the steps 41, 42, 431, 432, 44 and 45 are reiterated. If the answer is yes, a final step of addition of a residual value is performed before the signal is rendered by a speaker 47.

Each of these steps shall now be described in greater detail.

4.1 Intra Mode (Step 432)

We define Δ_{f}, Δₚ as being the respective quantification steps for the initial frequency and the prediction error on the phase (Δₚ may be different for the first phase value and the following values, since it can be made adaptive by the use of a quantifier at the adaptive quantification step). Appropriate values are of the order of π/32.

The notation index_f0 denotes the frequency index of the component encoded in Inter mode used as a reference. This index is an integer, enabling the rebuilding of the real value of the base frequency fₖ of the component indexed k in multiplying this index by the quantification step of the frequency Δ_{f}. The rebuilt value of fₖ, namely f̅ₖ, is obtained. In a second embodiment, index_f0 can be used for direct pointing in a table enabling the rebuilt values f̅ₖ of fₖ to be obtained.

Similarly, q[0], q[1] and q[index] are integers corresponding to a quantified value of the phase of the component indexed k by which a rebuilt value is obtained in multiplying them by the quantification step Δₚ applied to the phases. In a more detailed way, q[0] corresponds to the quantified value of the initial phase of a component, q[1] corresponds to the quantified value of the correction to be applied to the phase of a component at the instants that are multiples of m and q[index] corresponds to the quantified value of the correction to be applied to the phase at the instants indexed n (between the instants that are multiples of m).

The rebuilding of a component in Intra mode is done as follows:
building the base frequency of the component k from the quantification step of this value and its quantified value: f̅ₖ=Δ_{f}*index_f0;
building the initial value of the component k from the quantification step of this value and from its quantified value: \tilde{Φ}_{k,0}=Δₚ*q[0];
building the phase at the instant m of the component k from the initial phase of this component, its base frequency, the weighted instant considered and a weighted quantified value weighted by a quantification step: \tilde{Φ}_{k,m}=\tilde{Φ}_{k,0}+m·α· f̅ₖ+Δₚ*q[1];
building the phase at each instant that is a multiple of the decimation factor by extrapolation of the two preceding decimated instants and a quantified correction multiplied by a quantification step: \tilde{Φ}_{k,n}=2·\tilde{Φ}_{k,n-m}−\tilde{Φ}_{k,n-2m}+Δₚ*q[index];

The intermediate values between the indices n−m and n are rebuilt by means of the previously introduced equation:

$${Φ}_{k , n + l} = \frac{1}{m} [ ( m - 1 ) {\tilde{Φ}}_{k , n} + l \cdot \tilde{Φ} k , n + m ] .$$

If n is not a multiple, then the last values are extrapolated linearly: \tilde{Φ}_{k,n+m}=\tilde{Φ}_{k,n}+(m−n)ω with ω being proportional to the derivative of \tilde{Φ}_{k,n}.

4.2 Inter Mode (Step 431)

We shall now describe the decoding of a sinusoidal component indexed k encoded in Inter mode relative to a component indexed l already quantified in Inter mode (or possibly in Intra mode).

The rebuilding of a component in Inter mode is done as follows:
building the base frequency of the component indexed k from the quantification step of this value and from its quantified value: f̅ₖ=Δ_{f}*index_f0;
building the initial phase of the component k from the quantification step of this value and its quantified value: \tilde{Φ}_{k,0}=Δₚ*q[0];
building the phase at the instant indexed n of the component k from the phase at the time n−m of this component, its base frequency and the reference frequency l, the rebuilt phases of the reference component and a quantified correction multiplied by a quantification step:

$${\tilde{Φ}}_{k , n} = {\tilde{Φ}}_{k , n - m} + ( {\tilde{Φ}}_{l , n} - {\tilde{Φ}}_{l , n - m} ) \frac{{\overline{f}}_{k}}{{\overline{f}}_{l}} + {Δ}_{p} * q [ index ] .$$

The intermediate values between the indices n−m and n are rebuilt by means of the previously introduced equation:

$${Φ}_{k , n + l} = \frac{1}{m} [ ( m - 1 ) {\tilde{Φ}}_{k , n} + l \cdot \tilde{Φ} k , n + m ] .$$

If n is not a multiple of m, then the last values are extrapolated linearly: \tilde{Φ}_{k,n+m}=\tilde{Φ}_{k,n}+(m−n)ω, with ω being proportional to the derivative of \tilde{Φ}_{k,n}.

### 5. Rebuilding

Using the rebuilt evolved phases \tilde{Φ}_{k,n}, the frequencies and instantaneous phases are retrieved from the previously introduced equations φ_{k,n}=φₖ(nT)=mod(Φₖ(t=nT),2π) and, at choice, one of the functions

$${f}_{n + 1} = {f}_{n} - \frac{{Φ}_{k , n + 1} - {Φ}_{k , n}}{2 \cdot α T} or$$

$${f}_{n + 1} = \frac{{Φ}_{k , n + 1} - {Φ}_{k , n}}{α T}$$

also introduced in the introduction to the present description.

The instantaneous frequencies and instantaneous phases thus determined are then fed into the sinusoidal synthesizers (step 44) controlled by these values.

The set of sinusoidal components is then summated to retrieve the deterministic part of the audio signal.

This deterministic part is then optionally complemented by a residual signal (step 46) in the form of a comfort noise or by a signal encoded by an encoder by AAC type transform.

The complete signal thus rebuilt is then fed into a digital/analog converter enabling the sound to be rendered (step 47).

### 6. Implementation Devices

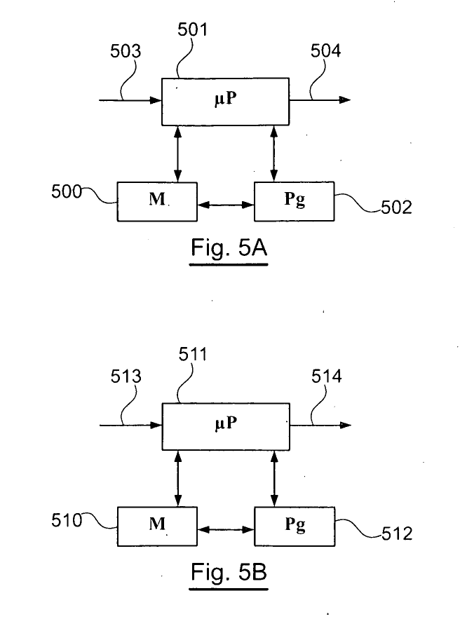

The method of an embodiment of the invention can be implemented by an encoding device whose structure is presented with reference to FIG. 5A.

A device of this kind comprises a memory M 500, a processing unit 501 equipped for example with a microprocessor and driven by the computer program Pg 502. At initialization, the code instructions of the computer program 502 are loaded for example into a RAM and then executed by the processor of the processing unit 501. At input, the processing unit 501 receives an audio source signal 503 to be encoded. The microprocessor μP of the processing unit 501 implements the encoding method described here above according to the instructions of the program Pg 502. The processing unit 501 outputs quantified data representing the encoded audio source signal 504.

An embodiment of the invention also relates to a device for the decoding of an encoded signal representing a source audio signal according to the embodiment of the invention, the general structure of which is represented schematically with reference to FIG. 5B. It comprises a memory M 510, a processing unit 511 equipped for example with a microprocessor and driven by the computer program Pg 512. At initialization, the code instructions of the computer program 512 are loaded for example into a RAM and then executed by the processor of the processing unit 511. At input, the processing unit 511 receives an encoded signal representing a audio source signal 513. The microprocessor μP of the processing unit 511 implements the decoding method according to the instructions of the program Pg 512 to deliver a rebuilt audio signal 512.

### 7. Appendix A

The relationship between f_{k,n} and the instantaneous frequency fₖ(t) is: f_{k,n}=fₖ(nT).

Similarly, the link between the phase φ_{k,n} and the instantaneous phase φₖ(t) is: φ_{k,n}=φₖ(nT).

So as to model the temporal progress, in the course of the signal, of the frequency and phase parameters, the notion of the evolved phase Φₖ(t) has been introduced. This notion relates, at the same time, to each of the sinusoidal components of the signal to be modeled, the instantaneous frequency fₖ(t) and the instantaneous phase φₖ(t). The evolved phase Φₖ(t) is therefore used to represent both the progress of the instantaneous phase and the instantaneous frequency of a partial value in the form of a single continuous temporal function which is then sampled. In other words, the progress of the initially introduced phase Φ_{k,n}(t) is modeled on the entire length of the signal.

In the ideal case, when the estimator responsible for breaking down the audio signal into partial values is perfect, the frequencies f_{k,n} and the instantaneous phases φ_{k,n} are related by the following two relationships:

$${f}_{k , n} = {f}_{k} ( nT ) = \frac{\partial {Φ}_{k} ( t = nT )}{\partial t} ;$$

φ_{k,n}=φₖ(nT)=mod(Φₖ(t=nT),2π), with mod(a,b) representing the modular function, i.e. the remainder of the integer division of a by b.

More specifically, there is a relationship between the value of the evolved phase at the frame n+1 and the value at the frame n, thus enabling an estimation of the evolved phase Φₖ(t) by prediction.

Indeed, from one frame indexed n to the next frame indexed n+1, the evolved phase is expressed by:

$${Φ}_{k , n + 1} = {Φ}_{k , n} + α {\int }_{nT}^{( n + 1 ) T} {f}_{k} ( t ) d t with α = \frac{2 π}{{F}_{e}} .$$

The term Δ_{Φk,n+1} here below denotes the variation of the evolved phase from one frame to the next one giving:

$${Δ}_{Φ k , n + 1} = {\int }_{nT}^{( n + 1 ) T} {f}_{k} ( t ) \cdot d t .$$

Should the frequency be considered to be constant in the course of time, the quantity Δ_{Φk,n+1} is constant in the course of time and the function Φₖ(t) is a straight line.

Should there be little variation fₖ(t) between the instants nT and (n+2)T, then the variation of the evolved phase is considered to be constant, i.e.: Δ_{Φk,n+2}≈Δ_{Φk,n+1} and then Φ_{k,n+2} is predicted by the following relationship: \hat{Φ}_{k,n+2}=2·Φ_{k,n+1}−Φ_{k,n}.

The estimation error or prediction: ε_{k,n+2}=Φ_{k,n+2}−\hat{Φ}_{k,n+2}.

The evolved phase divergence Δ_{Φk,n+1} between two instants is also called the phase evolution.

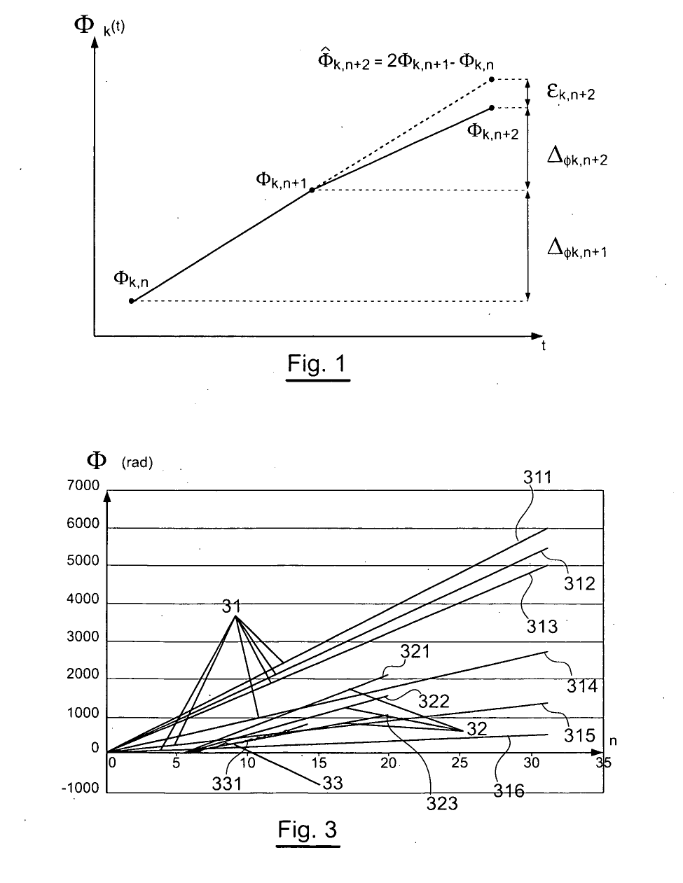

FIG. 1 illustrates the prediction of the evolved phase of the partial value indexed k, at the instants nT, (n+1)T and (n+2)T . The x-axis represents time and the y-axis represents the value of the evolved phase Φₖ(t).

It is noted that the prediction error ε_{k,n+2} is low as compared with the phase evolution Δ_{Φk,n+2}.

Again should the frequency of a partial value show little variation in time, a second possible variant for predicting the evolved phase, i.e. for deducing the value of the phase at an instant from its value at a previous instant lies in using the following relationship:

$${Φ}_{k , n + 1} = {Φ}_{k , n} + α T \frac{{f}_{n} + {f}_{n + 1}}{2} .$$

On the basis of the basic principle of encoding stipulating that a low-energy signal is far more costly to transmit than a high-energy signal, the classic technique consists then of the transmission or storage of all the elements ε_{k,n}. Since these elements are smaller than the elements Δ_{Φk,n}, they will be less costly in terms of bit rate or memory.

Having transmitted the initial evolved phase Φ_{k,0}, the phase at the next frame Φ_{k,1} as well as the sequence of elements {εₙ}_{n=2, . . . , N-1}, it is possible rebuild the initially determined phases and frequencies to the desired precision, according to the following relationships:

$${Φ}_{k , n + 2} = 2 \cdot {Φ}_{k , n + 1} - {Φ}_{k , n} + {ɛ}_{n} and$$

$${f}_{n + 1} = {f}_{n} - \frac{{Φ}_{k , n + 1} - {Φ}_{k , n}}{2 \cdot α T} ,$$

on the assumption that the conservation of the frequency which leads to the following approximation:

$${f}_{n + 1} = \frac{{Φ}_{k , n + 1} - {Φ}_{k , n}}{α T} .$$

### 8. Appendix B

Syntax of Transmission of the Evolved Phases

An example of a syntax of transmission of the Inter and Intra modes is presented in this paragraph.

The following table describes the syntax of the function <<read_sinus>> for reading the sinusoidal components.

| | | Number | Mne- |
|---|---|---|---|
| Syntax | | of bits | monic |
| read_sinus(index) | | | |
| { | | | |
| | intra_mode | 1 | uimsbf |
| | N | 7 | uimsbf |
| | if(intra_mode) { | | |

intra_sinus(N);
rebuilt_phase_intra(phase[index]);
base_index=index; // new reference

| intra index | | |
|---|---|---|
| | } | |
| | else | { |

inter_sinus(N);

| | rebuilt_phase_inter(phase[index],phase[base_i |
|---|---|
| ndex]); | |
| | } |

}

uimsbf means << unsigned integer most significant bit first >>.

The Intra/Inter mode is read so that it is possible to know the form in which the sinusoidal component is read. Depending on the mode read, the syntax is decoded and then the evolved phases are rebuilt according to the mode. The index of the Intra component serving as a reference for the next Inter component is constantly updated.

The following table describes the syntax of the <<intra_sinus>> function of detection of the Intra encoding mode.

| | | |
|---|---|---|
| Syntax | Number of bits | Mnemonic |

intra_sinus(N)
{

| | | |
|---|---|---|
| index_m | 4 | uimsbf |
| index_f0 | 10 | uimsbf |
| m=1+index_m; | | |
| K=(N−1)/m+1; | | |
| q[0] | 5 | uismbf |
| for(k=1;k<K;k++) { | | |

| | | |
|---|---|---|
| q[k]=Huff( ) | 2..31 | vlclbf |

}

}

vlclbf means << variable length code, least bit first >>.
Huff( ) is a function used to retrieve an index stored in the form of a variable length code.

The decimation index is read, followed by a frequency value. Then the initial phase is read followed by the prediction errors which will be used to rebuild the evolved phases.

The following table describes the syntax of the <<inter_sinus>> function of detection of the Inter encoding mode.

| | | |
|---|---|---|
| Syntax | Number of bits | Mnemonic |

inter_sinus(N)
{

| | | |
|---|---|---|
| index_m | 4 | uimsbf |
| index_f0 | 10 | uimsbf |
| m=1+index_m; | | |
| K=(N−1)/m+1; | | |
| q[0] | 5 | uismbf |
| for(k=1;k<K;k++) { | | |

| | | |
|---|---|---|
| q[k]=Huff( ) | 3..14 | vlclbf |

}

}

The decimation index is read followed by a frequency value. Then the initial phase is read followed by the prediction errors which will be used to rebuild the evolved phases.

Another alternative consists in not transmitting the index_f0 values for the components encoded in Inter mode. The ratio αₖ becomes implicit and rising in value: a component encoded in Inter mode after a component in Intra mode will have a default value αₖ=2 which is equivalent to

$$\frac{{\overline{f}}_{k}}{{\overline{f}}_{l}} = 2 ,$$

αₖ being increased by one at each reception of an Inter component until a new Intra-encoded component is encountered.

### 9. Conclusion

An embodiment of the present invention provides a novel technique for the parametrical encoding of signals, as well as a corresponding decoding technique. The proposed solution reduces transmission bit rate for a same rebuilding quality.

An embodiment of the present invention provides a technique that substantially reduces the memory space needed for the storage of an encoded harmonic signal.

An embodiment of the invention provides a technique that is particularly well suited to the transmission or storage of speech and music audio-digital signals and which enables the efficient coding of the sinusoidal components of such signals.

An embodiment of the invention provides a technique that is particularly efficient in terms of the transmission bit rate for sinusoidal components while at the same time generating a signal distortion that is the equivalent of or even lower than that obtained with the classic prior art techniques.

An embodiment of the invention proposes a technique of this kind that can be easily extended or is easily adaptable to most of the existing specifications in the different standards of the field of the encoding of multimedia signals such as the MPEG-4 standard especially.

Although the present disclosure has been described with reference to one or more examples, workers skilled in the art will recognize that changes may be made in form and detail without departing from the scope of the disclosure and/or the appended claims.

1. Method for encoding a source audio signal comprising:
a step of transformation of an amplitude/time space into a multi-component space described in terms of amplitude, phase and time, implementing a sinusoidal modeling of the audio signal and delivering a plurality of sinusoidal components varying in time;
comparing said components with one another so as to define at least one group of at least two components according to at least one predetermined similarity criterion;
encoding the following for at least one of said groups:
at least one piece of reference data of said group, said reference data being represented by an evolved phase derived from a first component of said group, called reference component;
at least one piece of complementary data associated with at least one of the components of said group and enabling the rebuilding, in combination with said reference information, of at least one piece of information representing at least one component.

2. Encoding method according to claim 1, wherein said criterion of similarity takes account of an evolution of the phase of at least two components.

3. Encoding method according to claim 2, wherein said comparison step implements a computation of correlation between said phase evolution of at least two components.

4. Encoding method according to claim 1, wherein said encoding step implements a differential encoding along a time axis comprising:
a step of prediction of said piece of reference data and/or of said piece of complementary data relative to at least one corresponding preceding value, delivering at least one piece of predicted data;
a step of determining at least one residue to be encoded, by difference between one of said pieces of predicted data and a corresponding real piece of data.

5. Encoding method according to claim 4, wherein said residue is encoded according to a period that is a multiple of the component extraction sampling period, and in that a piece of information representing said multiple is generated.

6. Encoding method according to claim 1, wherein said encoding step implements a differential encoding along a frequency axis comprising:
a step of encoding at least one piece of reference data, representing a reference component of said group;
a step of encoding at least one piece of complementary data representing another component of the group, by comparison with said piece of reference data.

7. Encoding method according to claim 6, wherein said encoding step implements the following equations for each component indexed k:
$${\hat{Φ}}_{k , n} = {\tilde{Φ}}_{k , n - 1} + \frac{{α}_{k}}{{α}_{l}} ( {\tilde{Φ}}_{l , n} - {\tilde{Φ}}_{l , n - 1} ) ;$$
$${d}_{k , n} = {Φ}_{k , n} - {\hat{Φ}}_{k , n} , where$$
n is a time index;
Φ_{k,n} is a value at an instant indexed n of a phase of the component indexed k;
\hat{Φ}_{k,n} is a piece of prediction data at an instant indexed n, of the phase of the component indexed k;
\tilde{Φ}_{k,n-1} is a piece of quantified data at an instant indexed n−1, of the phase of a harmonic component indexed k;
\tilde{Φ}_{l,n-1} is a piece of quantified data at an instant indexed n−1, of the phase of the component indexed l;
αₖ and αₗ are values proportional to basic frequencies of the components k and l, chosen so that the ratio of these values represents a ratio of frequency between a sinusoidal component indexed k and a sinusoidal component indexed l;
d_{k,n} is a residue value at an instant indexed n, between said phase value and said prediction data of the component indexed k.

8. Computer program product stored on a computer-readable carrier and executable by a microprocessor, wherein the product comprises program code instructions, which when executed perform a method of encoding a source audio signal comprising:
transforming an amplitude/time space into a multi-component space described in terms of amplitude, phase and time, implementing a sinusoidal modeling of the audio signal and delivering a plurality of sinusoidal components varying in time;
comparing said components with one another so as to define at least one group of at least two components according to at least one predetermined similarity criterion;
encoding the following for at least one of said groups:
at least one piece of reference data of said group, said reference data being represented by an evolved phase derived from a first component of said group, called reference component;
at least one piece of complementary data associated with at least one of the components of said group and enabling the rebuilding, in combination with said reference information, of at least one piece of information representing at least one component.

9. Device for encoding an audio source signal, comprising:
means of transformation of an amplitude/time space into a multi-component space described in terms of amplitude, phase and time, implementing a sinusoidal modeling of the audio signal and delivering a plurality of sinusoidal components varying in time;
means of comparing said components with one another so as to define at least one group of said at least two components according to at least one predetermined similarity criterion;
means of encoding the following for at least one of said groups:
at least one piece of reference data of said group, said reference data being represented by an evolved phase derived from a first component of said group, called reference component;
at least one piece of complementary data associated with at least one of the components of said group and enabling the rebuilding, in combination with said reference information, of at least one piece of information representing at least one component.

10. A method comprising:
producing an encoded signal representing a source audio signal, comprising a representation of the source signal in the form of a plurality of sinusoidal components described in a representation space in terms of amplitude, phase and time, said components being grouped together in at least one group of at least two components according to at least one predetermined similarity criterion, each of said groups comprising:
at least one piece of reference data of said group, said reference data being represented by an evolved phase derived from a first component of said group, called reference component;
at least one piece of complementary data associated with at least one of the components of the group and enabling the rebuilding, in combination with said piece of reference information, of at least one piece of information representing at least one component;
transmitting the encoded signal.

11. Data carrier comprising at least one encoded signal representing an audio source signal comprising a representation of the source signal in the form of a plurality of sinusoidal components described in a representation space in terms of amplitude, phase and time, said components being grouped together in at least one group of at least two components according to at least one predetermined similarity criterion, each of said groups comprising:
at least one piece of reference data of said group, said reference data being represented by an evolved phase derived from a first component of said group, called reference component;
at least one piece of complementary data associated with at least one of the components of said group and enabling the rebuilding, in combination with said piece of reference information, of at least one piece of information representing at least one component.

12. Method for decoding of an encoded signal representing a source audio signal, wherein,
said signal comprises a representation of the source signal in the form of a plurality of sinusoidal components described in a representation space in terms of amplitude, phase and time,
said components are grouped together in at least one group of at least two components according to at least one predetermined similarity criterion, each of said groups comprising:
at least one piece of reference data of said group, said reference data being represented by an evolved phase derived from a first component of said group, called reference component;
at least one piece of complementary data associated with at least one of the components of said group and enabling the rebuilding, in combination with said piece of reference information, of at least one piece of information representing at least one component.
said method comprises the steps of
obtaining said piece or said pieces of reference data and said piece or said pieces of complementary data;
rebuilding said information or said pieces of information representing said components, on the basis of said reference and complementary data.

13. Decoding method according to claim 12, wherein the method comprises building a rebuilt audio signal, representing said source audio signal, in taking account of said information representing said components.

14. Decoding method according to claim 12, wherein the method comprises:
a step of decoding of at least one piece of reference data, representing a reference component of said group;
a step of decoding of at least one piece of complementary data representing another component of the group, by comparison with said piece of reference data;
a step of rebuilding another component by combination of said piece of reference data and said piece or pieces of complementary data.

15. Decoding method according to claim 14, wherein said pieces of complementary data are encoded in a period that is a multiple of a sampling period, and wherein the method includes a step of interpolation of pieces of complementary data estimated for the sampling periods for which a piece of complementary data has not been encoded.

16. Decoding method according to claim 12, wherein the method implements the following equation:
$${\tilde{Φ}}_{k , n} = {\tilde{Φ}}_{k , n - m} + ( {\tilde{Φ}}_{l , n} - {\tilde{Φ}}_{l , n - m} ) \frac{{\overline{f}}_{k}}{{\overline{f}}_{l}} + {Δ}_{p} * q [ index ] where \text{:}$$
\tilde{Φ}_{k,n-m} is a piece of quantified data, at an instant indexed n−m, of a rebuilt phase of said component indexed k;
\tilde{Φ}_{l,n} is a piece of quantified data, at an instant indexed n, of the rebuilt phase of said component indexed l;
\tilde{Φ}_{l,n-m} is a piece of quantified data, at an instant indexed n−m, of the rebuilt phase of said component indexed l;
f̅ₖ is a value of a rebuilt frequency corresponding to said component;
f̅ₗ is a value of said rebuilt frequency corresponding to said component of the reference group;
Δₚ is a step of quantification of a quantification error
q[index] is an integer value corresponding to a quantified correction value.

17. Decoding method according to claim 12, wherein the method comprises:
a step of prediction along a time axis of said reference data relative to at least one corresponding preceding value, delivering at least one piece of predicted data;
a step of addition, to at least one of said predicted pieces of data, of a corresponding residue transmitted in said signal, so as to obtain a rebuilt real piece of data.

18. Computer program product stored on a computer-readable carrier and executable by a microprocessor, wherein the product comprises program code instructions implementing a method of decoding an encoded signal representing a source audio signal, wherein,
said signal comprises a representation of the source signal in the form of a plurality of sinusoidal components described in a representation space in terms of amplitude, phase and time,
said components are grouped together in at least one group of at least two components according to at least one predetermined similarity criterion, each of said groups comprising:
at least one piece of reference data of said group, said reference data being represented by an evolved phase derived from a first component of said group, called reference component;
at least one piece of complementary data associated with at least one of the components of said group and enabling the rebuilding, in combination with said piece of reference information, of at least one piece of information representing at least one component.
said method comprises the steps of
obtaining said piece or said pieces of reference data and said piece or said pieces of complementary data;
rebuilding said information or said pieces of information representing said components, on the basis of said reference and complementary data.

19. Device for the decoding of an encoded signal representing a source audio signal wherein
said signal comprises a representation of the source signal in the form of a plurality of sinusoidal components described in a space of representation in amplitude, phase and time,
said components are grouped together in at least one group of at least two components according to at least one criterion of similarity, each of said groups comprising:
at least one piece of reference data of said group, said reference data being represented by an evolved phase derived from a first component of said group, called reference component;
at least one piece of complementary data associated with at least one of the components of said group and enabling the rebuilding, in combination with said piece of reference information, of at least one piece of information representing a component,
said device comprises:
means to obtain said piece or pieces of reference data and said piece or pieces of complementary data;
means to rebuild said piece or pieces of information representing components from said pieces of reference and complementary data.
